(19) United States
(12) Patent Application Publication
(10) Pub. No.: US 2021/0082040 A1
(43) Pub. Date: Mar. 18, 2021

(54) SYSTEMS AND METHODS FOR CONFIGURING TRANSFERS

(71) Applicant: The Toronto-Dominion Bank, Toronto (CA)

(72) Inventors: Christopher Mark JONES, Villanova, PA (US); Nasim SARIR, Thornhill (CA); Marc CHALIFOUX, Toronto (CA); Sara KNECHTEL, Philadelphia, PA (US); Mohammad Fahad KHAN, Mississauga (CA)

(73) Assignee: The Toronto-Dominion Bank, Toronto (CA)

(21) Appl. No.: 16/571,641

(22) Filed: Sep. 16, 2019

(51) Int. Cl. G06Q 40/02; G06Q 20/26

(52) U.S. Cl. CPC G06Q 40/02; G06Q 20/26

(57) ABSTRACT

A method of processing a value transfer by a computer system may include obtaining an amount of a value transfer to be made using a primary transfer source. Responsive to determining that an available transfer quantity associated with the primary transfer source for effectuating the value transfer is less than the amount of the value transfer, a selectable option to use an existing secondary transfer source for effectuating at least a portion of the instructed value transfer is provided. Responsive to receiving, based on the selectable option to use the existing secondary transfer source for effectuating at least the at least a portion of the instructed value transfer, a transfer of value using the existing secondary transfer source for effectuating the at least a portion of the instructed value transfer is initiated. Related computer systems and methods are also disclosed.

### FIELD

This relates to electronic data transfers, and, more particularly, to providing user interfaces for identifying secondary transfer sources to fulfill data transfers.

### BACKGROUND

A sender may initiate a transfer from a source to a destination. Transfers between senders and receivers may occur for a variety of reasons. For example, a quantity may be being transferred from the source to the destination. In order to make a transfer between a source and a destination, configuration may be required, including, for example, to identify the source, destination, and/or that which is being transferred.

### BRIEF DESCRIPTION OF THE DRAWINGS

Embodiments are described in detail below, with reference to the following drawings:

FIG. 1 is a schematic operation diagram illustrating an operating environment of an example embodiment that includes a computing device;

FIG. 2 shows the front of the computing device of FIG. 1;

FIG. 3 is a high-level schematic diagram of the computing device of FIG. 1;

FIG. 4 shows a simplified organization of software components stored in a memory of the computing device of FIG. 1;

FIG. 5 is a flowchart showing operations performed by the computing device of FIG. 1 in configuring a transfer;

FIG. 6 shows a user interface for configuring a transfer;

FIG. 7 shows a user interface for selecting a configuring one or more sources for originating transfers;

FIG. 8 shows a user interface for adding a new transfer source;

FIG. 9 shows a second user interface for configuring a transfer;

FIG. 10 shows third user interface for configuring a transfer; and

FIG. 11 is a flowchart showing operations performed by a remote computing device in configuring a transfer.

Like reference numerals are used in the drawings to denote like elements and features.

### DETAILED DESCRIPTION OF VARIOUS EMBODIMENTS

According to the subject matter of the present application, there may be provided a computer system. The computer system may include a processor, a communications module, an input module, an output module and a memory. The communications module, the input module, the output module, and the memory may be coupled to the processor. The memory may store instructions associated with a value transfer application. The instructions, when executed by the processor, may cause the computer system to: authenticate, using the communications module, the computer system to a remote server using a credential, the credential associated with an account at the remote server, the account associated with a primary transfer source for effectuating an instructed value transfer; obtain, using at least one of the input module and the communications module, an amount of the instructed value transfer; obtain, from the remote server using the communications module, an available transfer quantity associated with the primary transfer source for effectuating the instructed value transfer; responsive to determining, by the processor, that the available transfer quantity is less than the amount of the instructed value transfer, provide, using the output module, a selectable option to use an existing secondary transfer source for effectuating at least a portion of the instructed value transfer; and responsive to receiving input via the selectable option to use the existing secondary transfer source for effectuating at least a portion of the instructed value transfer, send, to the remote server using the communications module, an instruction to use the existing secondary transfer source for effectuating the at least a portion of the instructed value transfer.

In this way, a value transfer may be configured to use a secondary transfer source responsive to detecting that a primary transfer source cannot satisfy a desired transfer quantity. For example, where the transfer corresponds to a transfer of funds, upon detecting that a primary transfer source—such as, for example, a bank account—has an insufficient available balance to satisfy an intended transfer, an option may be provided allowing the use of a secondary transfer source (e.g., a credit or debit card) as a source for the transfer. Conveniently, in this way, transfers may be configured that would not be possible to make (e.g., due to insufficient available quantity in the primary transfer source alone) without the use of a secondary transfer source.

In some implementations, providing the selectable option to use the existing secondary transfer source for effectuating the at least a portion of the instructed value transfer may include: providing, using the output module, one or more selectable options to input a relative portion of the amount of the instructed value transfer to be associated with the primary transfer source and a relative portion of the amount of the instructed value transfer to be associated with the secondary transfer source. The instruction to use the existing secondary transfer source for effectuating the at least a portion of the instructed value transfer may include an indication of the relative portion of the amount of the instructed value transfer to be associated with the secondary transfer source.

In some implementations, the instructions may further cause the computer system to determine, by the processor, a difference between the amount of the instructed value transfer and the available transfer quantity associated with the primary transfer source. The instruction to use the existing secondary transfer source for effectuating the at least a portion of the instructed value transfer may include an indication to configure a transfer of value from the secondary transfer source based on the difference.

In some implementations, the primary transfer source may include a deposit account associated with a first financial institution. The secondary transfer source may include a debit payment from an account associated with a second financial institution, the second financial institution different from the first financial institution. In some implementations, the value transfer application may be a banking application of the first financial institution.

In some implementations, the secondary transfer source may be associated with revolving credit facility. For example, the revolving credit facility may include a credit card account.

In some implementations, the option to use the existing secondary transfer source for effectuating at least a portion of the instructed value transfer may include a selectable option to add the existing secondary transfer source. In such implementations, the instructions, when executed by the processor, may further cause the computer system to: receive, using the input module, an indication representing selection of the selectable option to add the existing secondary transfer source; after receiving the indication representing selection of the selectable option to add the existing secondary transfer source, receive, using the input module, information associated with the existing secondary transfer source; and provide, using the output module, a list of available transfer sources for initiating the instructed value transfer, the list including at least the primary transfer source and the secondary transfer source. It may be that receiving information associated with the existing secondary transfer source includes: generating, using the output module, a prompt for input of identification data associated with the existing secondary transfer source; receiving, using the input module, the identification data; and verifying the identification data.

According to the subject matter of the present application, there may be provided a computer system. The computer system may include a processor, a communications module, and a memory. The communications module and the memory may be coupled to the processor. The memory may store instructions that, when executed by the processor, cause the computer system to: obtain, using the communications module from one of a client device and a remote server system, an amount of an instructed value transfer to be made using a primary transfer source for effectuating the instructed value transfer, the primary transfer source associated with the computer system; responsive to determining, by the processor, that an available transfer quantity associated with the primary transfer source for effectuating the instructed value transfer is less than the amount of the instructed value transfer, send, to the client device, an output instruction to provide, on an output module of the client device, a selectable option to use an existing secondary transfer source for effectuating at least a portion of the instructed value transfer; receive, from the client device using the communications module, an instruction to use the secondary transfer source for effectuating the at least a portion of the instructed value transfer; and responsive to receiving the instruction to use the existing secondary transfer source for effectuating at least the at least a portion of the instructed value transfer, configure the instructed transfer of value using the existing secondary transfer source.

In some implementations, the instructions may further cause the computer system to: determine, by the processor, a difference between the amount of the instructed value transfer and the available transfer quantity associated with the primary transfer source. The transfer of value from the secondary transfer source may be configured based on the difference.

In some implementations, the primary transfer source may be a deposit account associated with a first financial institution. The secondary transfer source may include a debit payment from an account associated with a second financial institution, the second financial institution different from the first financial institution.

In some implementations, the secondary transfer source may be associated with revolving credit facility.

According to the subject matter of the present application, there may be provided a computer-implemented method. The method may include obtaining an amount of an instructed value transfer to be made using a primary transfer source for effectuating the instructed value transfer; responsive to determining that an available transfer quantity associated with the primary transfer source for effectuating the instructed value transfer is less than the amount of the instructed value transfer, providing a selectable option to use an existing secondary transfer source for effectuating at least a portion of the instructed value transfer; and responsive to receiving, based on the selectable option to use the existing secondary transfer source for effectuating at least the at least a portion of the instructed value transfer, initiating a transfer of value using the existing secondary transfer source for effectuating the at least a portion of the instructed value transfer.

In some implementations, the computer-implemented method may further include: receiving an indication of input defining a relative portion of the amount of the instructed value transfer to be associated with the primary transfer source and a relative portion of the amount of the instructed value transfer to be associated with the secondary transfer source. It may be that the transfer of value from the secondary transfer source is configured based on the relative portion of the amount of the instructed value transfer to be associated with the secondary transfer source.

In some implementations, the computer-implemented method may further include: determining a difference between the amount of the instructed value transfer and the available transfer quantity associated with the primary transfer source. It may be that the transfer of value from the secondary transfer source is configured based on the difference.

In some implementations, the primary transfer source may include a deposit account associated with a first financial institution.

In some implementations, the secondary transfer source may include a credit card account.

According to the subject matter of the present application, there may be provided a computer-readable medium. In some implementations, the computer-readable medium may be a non-transitory computer-readable medium. The computer-readable medium may store instructions that, when executed by a processor of a computer system, cause the computer system to perform the above-discussed method.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

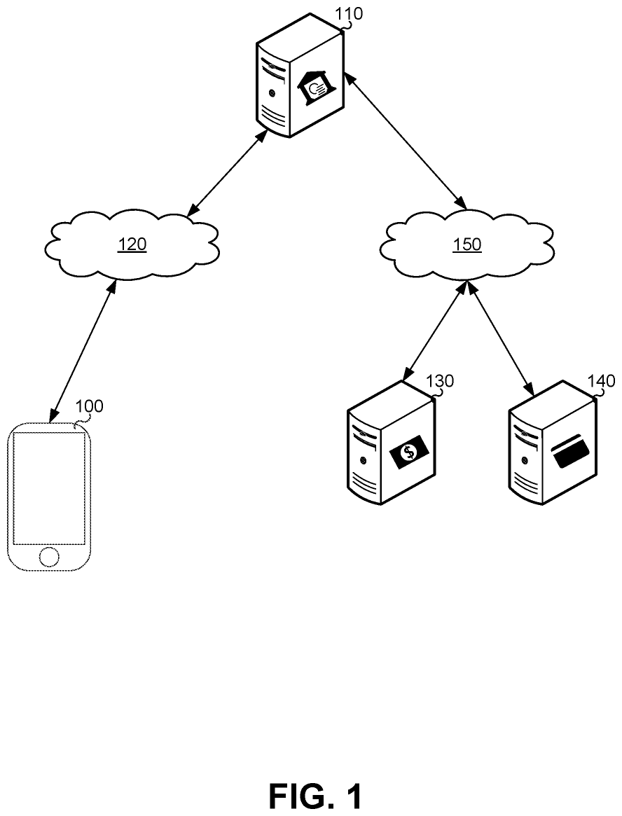

FIG. 1 is a schematic operation diagram illustrating an operating environment of an example embodiment.

As illustrated, a computer system 100 is in communication with a first server computer system 110 via a first network 120. Further, the first server computer system 110 is in communication with a second server computer system 130 and a third server computer system 140 via a second network 150.

The computer system 100 is a computing device. The computer system 100 may, for example, be a smartphone as shown. In another example, the computer system 100 may be a computing device of another type such as a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays), and any other type of computing device that may be configured to store data and software instructions, and execute software instructions to perform operations consistent with disclosed embodiments.

The first server computer system 110, the second server computer system 130, and the third server computer system 140 are or include one or more computing devices. The first server computer system 110 and the second server computer system 130 are computer server systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, compute servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

Notably, each of the above-mentioned computing devices includes at least one hardware processor configured to fetch, decode, and execute instructions from one or more computer-readable mediums. For example, such a computer-readable medium may be a memory. In another example, such a computer-readable medium may be a non-transitory computer-readable medium.

The first network 120, and the second network 150 are computer networks. In some embodiments, the first network 120 and the second network 150 may be the same network. A computer network may be an internetwork such as may be formed of one or more interconnected computer networks. For example, a computer network may be or may include an Ethernet network, an asynchronous transfer mode (ATM) network, a wireless network, and/or the like. Additionally or alternatively, one or more devices may communicate with a computer network by way of a plain-old telephone service (POTS) line such as using a modem. In a particular example, one or both of the first network 120 and the second network 150 may be the Internet.

The first server computer system 110 provides functionality including allowing for the configuration of transfers. For example, the first server computer system 110 may be associated with a financial institution and may allow for the configuration of financial transfers such as may, for example, correspond to payments. In some such cases, the first server computer system 110 may, for example, be responsible for debiting and/or crediting one or more financial accounts involved in a transfer (and/or initiating the same).

The second server computer system 130 and the third server computer system 140 cooperate with the first server computer system 110 to effect transfers.

In the illustrated example, the transfers may, as mentioned above, be financial in nature such as, for example, payments. The second server computer system 130 may be associated with a financial services provider that effects the payments. In a particular example, the second server computer system 130 may be associated with Fiserv, Inc. of Brookfield, Wis., U.S.A. The third server computer system 140 may be associated with one or more payment networks such as may be employed in processing one or more financial transfers. In a particular example, the third server computer system 140 may be associated with one or more of the Visa™ VisaNet™ electronic payments network and/or Mastercard™ Banknet™, or the like.

As further described below, the computer system 100 provides a user-interface allowing configuration of transfers. In particular, the computer system 100 co-operates with the first server computer system 110 to configure transfers. Various of the first server computer system 110, the second server computer system 130, and/or the third server computer system 140 then co-operate to effect the transfers.

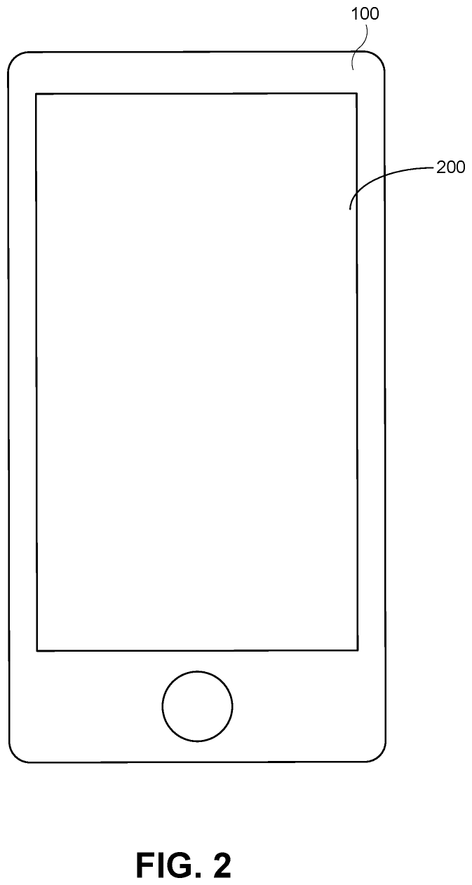

As mentioned above, the computer system 100 may be a smartphone as shown in FIG. 1. FIG. 2 is a diagram showing such an embodiment of the computer system 100.

As illustrated, the computer system 100 includes a display 200. The display 200 is a module of the illustrated embodiment of the computer system 100. The display 200 is for presenting graphics. The display 200 may be, for example, a liquid crystal display (LCD). In addition to being an output device, the display 200 may also be an input device. For example, the display 200 may allow touch input to be provided to the computer system 100. In other words, the display 200 may be a touch sensitive display module. In a particular example, the display 200 may be a capacitive touch screen.

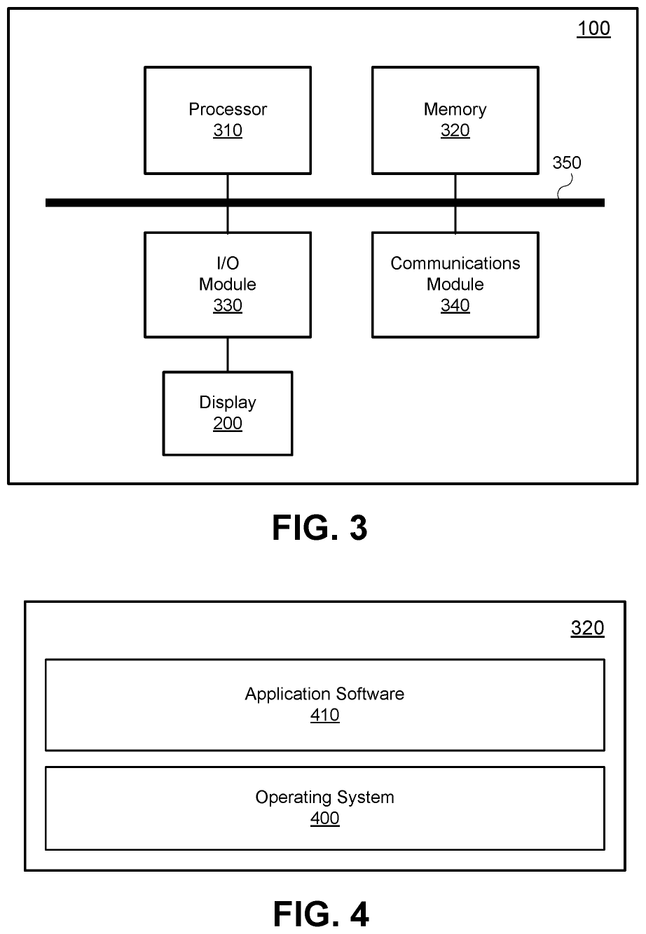

FIG. 3 is a high-level schematic diagram of the embodiment of the computer system 100 depicted in FIG. 2.

The computer system 100 includes a variety of modules. For example, as illustrated, the computer system 100 may include a processor 310, a memory 320, an I/O module 330, and/or a communications module 340. As illustrated, the foregoing example modules of the computer system 100 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are each computer-readable storage media and may each be considered non-transitory computer-readable storage medium. A computer-readable medium may be organized using a file system such as may be administered by an operating system governing overall operation of the computer system 100.

The I/O module 330 is both an input module and an output module. The I/O module 330 allows the computer system 100 to receive input from and/or to provide output to components of the computer system 100. For example, the I/O module 330 may, as shown, allow the computer system 100 to receive input from and/or provide output to the display 200.

The communications module 340 allows the computer system 100 to communicate with other computing devices and/or various communications networks such as, for example, the first network 120. The communications module 340 may allow the computer system 100 to send or receive communications signals. Communications signals may be sent or received according to one or more protocols or according to one or more standards. For example, the communications module 340 may allow the computer system 100 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 340 may allow the computer system 100 to communicate via Wi-Fi™, using Bluetooth™ or via some combination of one or more networks or protocols. In some embodiments, all or a portion of the communications module 340 may be integrated into a component of the computer system 100. For example, the communications module 340 may be integrated into a communications chipset.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the computer system 100. As illustrated, these software components include an operating system 400 and an application software 410.

The operating system 400 is software. The operating system 400 allows the application software 410 to access the processor 310 (FIG. 2), the memory 320, the I/O module 330, and the communications module 340 of the computer system 100. The operating system 400 may be, for example, Google™ Android™, Apple™ iOS™, UNIX™, Linux™, Microsoft™ Windows™, Apple OSX™ or the like.

The application software 410 adapts the computer system 100, in combination with the operating system 400, to allow a user to configure transfers. The application software 410 may be referred to as a value transfer application. Where the computer system 100 is a smartphone or tablet, the application software 410 may itself be or may be a part of a smartphone or tablet application or “app”. In a particular example, where the transfers are financial transfers, the application software 410 may be a banking application such as, for example, a mobile banking application (“mobile banking app”). For example, where, as further described below, a particular account serves as the primary transfer source for financial transfers being instructed, the banking application may be associated with and/or provided by the financial institution with which the particular account is associated.

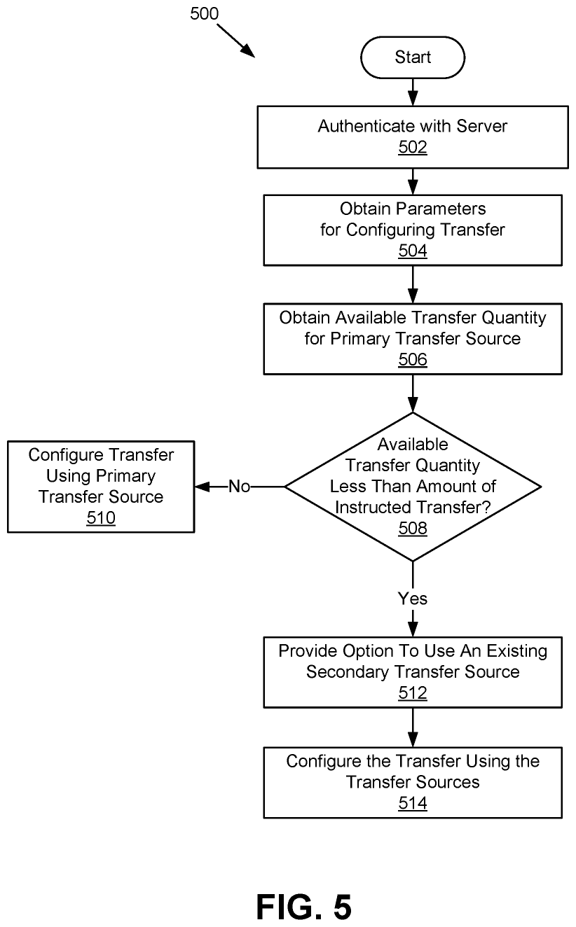

The operation of the computer system 100 will now be described with reference to the flowchart of FIG. 5 which illustrates a method 500 for configuring transfers. In performing the method 500, operations starting from an operation 502 and continuing onward are performed by processors of one or more computing devices executing software comprising instructions. For example, some or all of the operations may be performed by the processor 310 of the computer system 100 executing software a suitable instance of the application software 410 (FIG. 4). Additionally or alternatively, some or all of the operations may be performed by a processor of another computer system such as, for example, the first server computer system 110, the second server computer system 130, and/or the third server computer system 140. Furthermore, it could be that some of the operations of the method 500 may be decomposed into sub-operations. Potentially, various sub-operations of a given operation may be performed by different processors/different computer systems. In a particular example, two or more of the computer system 100, the first server computer system 110, the second server computer system 130, and/or the third server computer system 140 may co-operate (e.g., via one or both of the first network 120 and the second network 150) in order to perform the method 500, with processors of the various computer systems performing various operations of the method 500 (and/or sub-operations thereof).

At the operation 502, the computer system 100 authenticates with a remote server system such, as for example, the first server computer system 110. The authenticating may involve an exchange of communications between the computer system 100 and the remote server system such as, for example, by way of the first network 120. The communicating may use the communications module 340 (FIG. 3). In a particular example, the computer system 100 may send a credential associated with a particular account to the first server computer system 110 to authenticate so as to allow that account to be used in making transfers. Put another way, the authentication may use a credential associated with an account at the remote server. The credential may, for example, be a password such as may be obtained by the computer system 100 by way of input received such as, for example, by way of an input device such as the display 200 (e.g., where it is a touch screen). As further described below, the account may be associated with one or more sources for transfers.

Following the operation 502, an operation 504 is next. At the operation 504, parameters for configuring a transfer are obtained. For example, at the operation 504, an amount of the intended transfer is obtained. Additionally or alternatively, at the operation 504, a source for effectuating the instructed transfer—a primary transfer source—may be identified. The transfer source may take a variety of forms. For example, where the transfer corresponds to a financial transaction (e.g., a payment), the primary transfer source may correspond to an account such as, for example, a financial institution account. In a particular example, the primary transfer source may be a deposit account such as, for example, a checking account or a savings account. The primary transfer source may be identified based on an instruction such as may, for example, be received identifying a primary transfer source. In some embodiments, the instruction identifying the transferee and the instruction identifying the primary transfer source may be distinct. Alternatively, they may be one and the same. As an alternative to identifying a transfer source based on an instruction, a primary transfer source may be identified in another fashion. For example, the primary transfer source may be identified based on the account to which authentication was performed at the operation 502 and/or may be a default associated therewith. In a particular example, the primary transfer source may be associated with the account.

The various parameters for configuring the transfer (e.g., the amount of the transfer, the primary transfer source, etc.) may be obtained/identified in a variety of manners. For example, some or all of the parameters may be obtained using a communications module (e.g., the communications module 340 (FIG. 3)) such as, for example, from a remote server such as, for example, the first server computer system 110 via one or more networks such as, for example, the first network 120. Additionally or alternatively, some or all of the parameters may be obtained by way of input received via an input device. In a particular example, input may be received by way of the I/O module 330 (FIG. 3) from a suitable input device such as, for example, the display 200 where the display 200 is a touchscreen.

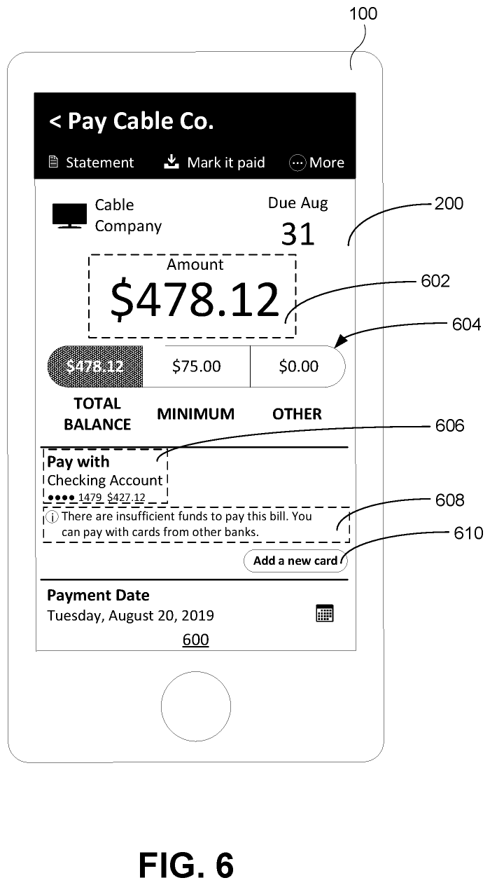

An example transfer configuration graphical user interface 600 such as may be presented for instructing a transfer and configuring parameters thereof is shown in FIG. 6. As illustrated, the display 200 is displaying the example transfer configuration graphical user interface 600. The example transfer configuration graphical user interface 600 may be a touch sensitive interface. As discussed above, the transfer being configured may, in some embodiments, correspond to a payment. For example, a given transfer may correspond to payment for a bill and/or an invoice. As such, the example transfer configuration graphical user interface 600, as shown, characterizes its purpose as configuring a bill payment. In particular, in the illustrated example, a payment to a cable company is being configured.

The example transfer configuration graphical user interface 600 includes an indication 602 of the amount of the bill related to which the payment is being configured. The indication 602 may be determined based on an electronic statement such as, may for example, be made available to an institution associated with the first server computer system 110 such as, for example, a financial institution. Such an electronic statement may include metadata such as statement due date, amount due, etc. Such an electronic statement may be provided to the first server computer system 110 (e.g., via a network). Additionally or alternatively, an intermediary may make such electronic statements available. An example of a possible intermediary is Fiserv, Inc. which, as mentioned above, may be associated with the second server computer system 130. Accordingly, it may be that the second server computer system 130 provides electronic statements to the first server computer system 110 such as, for example, by way of the second network 150.

The example transfer configuration graphical user interface 600 also includes a control 604. The control 604 allows the amount of the transfer being instructed to be selected. Put another way, an amount of the instructed transfer may be obtained by way of input received via the control 604. Notably the control 604 includes options for the amount of the transfer to be the total balance owing, the minimum payment owing, or some other user-provided amount. In the first two cases, these amounts may be provided based on metadata such as, for example, as may be obtained from an electronic statement as discussed above. If the user-selected amount (“OTHER”) option is selected, input specifying an amount may be provided. For example, an on-screen keyboard (not shown) may be provided allowing input of an amount. In some cases (not shown), instead of the control 604, a control allowing entry of an amount (i.e., without an option to pay the balance and/or without an option to pay the minimum payment) may be provided such as, for example, where metadata identifying the balance and/or the minimum payment is unavailable.

In the illustrated example, input has been provided configuring the control 604 to select payment of the total balance ($478.12). Further, the primary transfer source has been identified as a particular checking account as depicted in an indication 606.

In some implementations, provision may be made for selection of a primary transfer source other than the default source. For example, it may be that the indication 606 is selectable and that input selecting the indication 606 may be provided (e.g., by touching or clicking on the indication 606) to allow a different primary transfer source to be selected. Responsive to such a selection, a further user interface may be provided allowing selection between other previously configured transfer sources. Additionally, such a user interface may allow configuration of a new (not previously configured) transfer source.

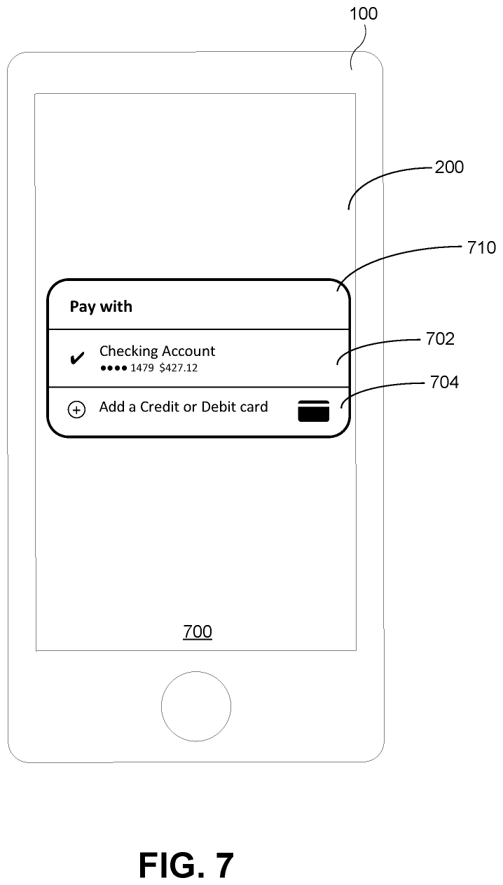

An example transfer source selection user interface 700 is shown in FIG. 7. The example transfer source selection user interface 700 includes a user interface control 710 listing previously configured transfer sources. In particular, as illustrated, a single transfer source, namely the checking account having an account number ending 1479 is listed via a first selectable option 702. A second selectable option 704 is also provided allowing configuration of additional transfer sources. In particular, as illustrated, the second selectable option 704 allows a payment card to be configured as a transfer source. Notably such a payment card may be associated with a different financial institution from the financial institution with which the checking account is associated and/or a financial institution different from the institution providing the software application being employed for configuring the transfer.

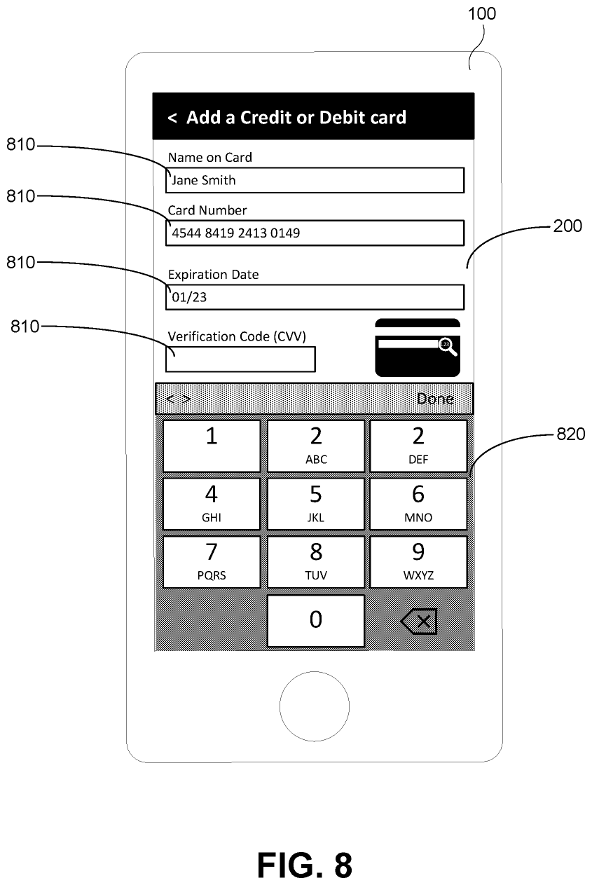

Responsive to selection of an option to configure an additional transfer source, a corresponding user interface may be provided. For example, responsive to selection of the second selectable option 704 (e.g., by touch and/or by click using a pointing device), a user interface for adding a credit or debit card may be provided. An example payment card configuration user interface is shown in FIG. 8. The illustrated user interface includes a set of data entry fields 810 allowing entry of the particulars of a given payment card using an on-screen keyboard 820. More broadly, a user interface such as that depicted allows a prompt for input of identification data for a secondary transfer source to be presented. That identification data can then be received such as, for example, by way of an input module such as the I/O module 330. Finally, received identification data may be verified. For example, in the case of a credit card, a test authorization may be made to confirm the card information. In another example, where a billing address for a card is provided, a system such as, for example, the Address Verification System (AVS) may be used to verify that address. In some embodiments, only some of the entered information may be saved between sessions. For example, it may be that the card verification value (CVV) (denoted “Verification Code (CVV)” in FIG. 8) is used in verifying a card but is not persisted between sessions. As such, it may be that the CVV will be required in order to use an added payment card in a subsequent session. For example, this may be required in order to comply with Payment Card Industry (PCI) standards.

In some implementations, once an additional transfer source is added (such as, for example, by way of a graphical user interface akin to that depicted in FIG. 8), the added transfer source may be selected as a primary transfer source. For example, the added transfer source could be selected as the primary transfer by way of a graphical user interface such as, for example, the example transfer source selection user interface 700 (FIG. 7).

The discussion now returns to consideration of FIG. 5 where, in the method 500, following the operation 504, an operation 506 is next.

At the operation 506, an available transfer quantity for the primary transfer source identified at the operation 504 is obtained. For example, where the primary transfer source is an account, the available transfer quantity may correspond to an account balance. In a particular example, where the transfer source is a bank account, the available transfer quantity may correspond to an available account balance. For example, the available transfer quantity may be the account balance less any holds on funds (e.g., less holds for recently deposited checks). In another example, the available transfer quantity may be based on the available account balance less one or more other reserve amounts. For example, it may be that a minimum balance is associated with the account (e.g., as selected by an owner of the account) and that the available transfer quantity is determined based on the available balance less that minimum balance. Conveniently, in this way, a minimum balance to avoid bank fees may, for example, be maintained. In another example, it may be that the available transfer quantity is determined based on the available balance less any reserves for upcoming known or projected payments. For example, reserves may be considered to exist for any scheduled transfers (schedule bill payments) as will occur in the future. Additionally or alternatively, reserves may be made for projected transfers such as, for example, recurring payments drawn from the account automatically (e.g., for automated clearing house (ACH)/direct debit payments). In a given implementation, determination of the available transfer quantity may take into account (i.e., be based on) some or all of the foregoing example reserve amounts.

The available transfer quantity may be obtained from a remote server such as may be associated with the primary transfer source. For example, the available transfer quantity may be obtained from the first server computer system 110. The available transfer quantity for the primary transfer source for effectuating the instructed value transfer may be obtained from the remote server by using the communications module 340 (FIG. 3) to communicate via a network such as, for example, the first network 120.

Additionally, in some implementations, at the operation 506, an indication of the available transfer quantity may be presented as output. For example, as shown in FIG. 6, the indication 606 includes an indication of the available transfer quantity (available balance) in the identified primary transfer source, namely the checking account having an account number ending 1479. In particular, the indication 606 indicates an available balance of $427.16.

Returning again to discussion of FIG. 5, following the operation 506, an operation 508 is next.

At the operation 508, it is determined whether the available transfer quantity obtained at the operation 506 is less than the amount of the value transfer obtained at the operation 504. Notably, in some embodiments, the determination as to whether the available transfer quantity obtained at the operation 506 is less than the amount of the value transfer obtained at the operation 504 may be made by the processor 310 of the computer system 100. Additionally or alternatively, the determination may be made by a processor of a remote computing device such as, for example, the first server computer system 110. In a particular example, the determination may be made through co-operation between the computer system 100 and the first server computer system 110. However determined, if it is determined that the available transfer quantity is not less than (i.e., is greater than or equal to) the amount of the instructed value transfer, an operation 510 is next. Alternatively, if it is determined that the available transfer quantity is less than the amount of the instructed value transfer, an operation 512 is next.

At the operation 510, having determined that the available transfer quantity is not less than the amount of the instructed value transfer, the transfer is configured to be sourced from the primary transfer source alone. For example, the transfer may be configured through co-operation between the computer system 100 and one or both of the first server computer system 110, the second server computer system 130, and the third server computer system 140.

Alternatively, responsive to determining that the available transfer quantity is less than the amount of the instructed value transfer, at the operation 512, an option to use a secondary transfer source is provided via an output module such as, for example, using the I/O module 330. More particularly, an option is provided to use an existing secondary transfer source. “Existing” refers to the fact that the transfer source already exists. Put another way, “existing” means that a new account or transfer source is not being created; instead, an already-created (but not previously configured) source can be identified and used in completing the transfer.

Notably, the option is provided responsive to the determination that the transfer quantity available from the primary transfer source is less than the amount of the instructed value transfer made at the operation 508. As mentioned above, this determination may be made at the computer system 100 and/or by a co-operating remote computing device. In one example, where a co-operating remote computing device makes the determination that the available transfer quantity associated with the primary transfer source for effectuating the instructed value transfer is less than the amount of the instructed value transfer, the remote computing device may send an instruction to the computer system 100 to cause it to provide the selectable option to use an existing secondary transfer source for effectuating at least a portion of the instructed value transfer and it may be that it is this output instruction that triggers the display of such a selectable option (and potentially the operation 512 to be performed).

However the provision of the selectable option to use an existing secondary transfer source is triggered, possible secondary transfer sources that may be selected may take a variety forms depending, for example, on the nature of the transfer. For example, in the case of a transfer corresponding to a financial payment, a secondary transfer source may correspond to a payment account and/or payment card such as, for example, the additional payment sources such as may, in some implementations, be selectable as alternative primary transfer sources as discussed above. In another particular example, a secondary transfer source may correspond to (i.e., may be or may include) a debit card as discussed above. For example, a Visa™ branded debit card and/or, in Canada, an Interac™ branded debit card may act as a secondary transfer source. Notably, the use of a debit card as a secondary transfer source may allow access to funds from a deposit account at a financial institution different from the primary transfer source and/or different from the financial institution associated with the software application being used to configure the transfer. Put another way, the secondary transfer source may allow a debit payment from an account associated with a second financial institution different from a financial institution associated with the primary transfer source. Additionally or alternatively, in another example, a secondary transfer source may correspond to (i.e., may be or may include) a revolving credit facility. In a particular example, a secondary transfer source may correspond to a credit card account such as, for example, an account associated with a Visa™ or Mastercard™ branded credit card.

Notably, as further described below, the existing secondary transfer source may or may not be already known to and/or configured such that it can be immediately employed as a transfer source. Put another way, it may be necessary to add and/or configure an existing transfer source to allow it to be used in effectuating the transfer.

Manners of providing an option to use an existing secondary transfer source will now be discussed. By way of overview, various example graphical user interfaces depicted in FIGS. 6 and 9-11 will be discussed. Each of those example user interfaces includes one or more selectable options to use an existing secondary transfer source for effectuating at least a portion of an instructed value transfer.

Returning to consideration of FIG. 6, in the example transfer configuration graphical user interface 600 adjacent the indication 606, a warning 608 is provided indicating the condition detected at the operation 508, namely that the primary transfer source (the checking account indicated by the indication 606) has insufficient funds (available balance) to pay the selected amount ($478.12)—i.e., the available balance is less than the amount selected for transfer using the control 604. An indication akin to the warning 608 may be provided whenever the selected transfer amount is greater than the available amount from the primary transfer source. Additionally or alternatively, in some implementations, a similar warning (not shown) may be provided when the total balance owing of a bill (where known) is greater than the amount available to transfer from the primary transfer source.

The example transfer configuration graphical user interface 600 also includes a selectable option, a button 610, to allow a selection to use an existing secondary transfer source (in the illustrated case, a payment card) for effectuating some or all the instructed value transfer (i.e., at least a portion of the cable bill). Responsive to selection of the button 610 (e.g., by touch and/or clicking it using a pointing device), a user may identify a payment card for use in satisfying some or all of the payment transfer. For example, after receiving an indication representing selection of the button 610, a user interface akin to the user interface depicted in FIG. 8 and discussed above may be presented. In this way, information may be received (e.g., via the I/O module 330), associated with an existing secondary transfer source allowing it to be used for the transfer.

Responsive to the addition of a secondary transfer source, a list of available transfer sources for initiating the payment may be provided, with such a list including both the primary transfer source and the newly-configured secondary transfer source. For example, a user interface akin to the example transfer source selection user interface 700 (FIG. 7) may be provided to allow selection of a secondary transfer source.

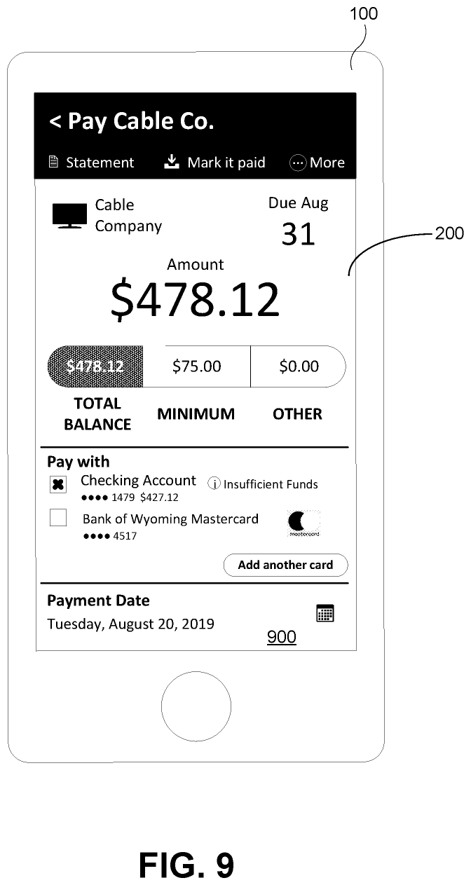

In another example, a user interface may be provided allowing multiple transfer sources to be selected. For example, a second example transfer configuration interface 900 is depicted in FIG. 9. The second example transfer configuration interface 900 is similar to the example transfer configuration graphical user interface 600 and may operation in a generally similar fashion thereto. Notably, however, different from the example transfer configuration graphical user interface 600, the second example transfer configuration interface 900 includes a list of available transfer sources for initiating the value transfer, that listing including the primary transfer source (the checking account with an account number ending 1479) and a possible secondary transfer source, namely a Mastercard with a number ending 4517. In particular, the listed transfer sources are selectable, allowing a primary transfer source and a secondary transfer source (or potentially multiple secondary transfer sources) to be selected.

Where more than one transfer source is identified for satisfying a selected transfer source, identification of one of those transfer sources as primary may be made in a variety of manners. In a first example, the identification may be based on input. For example, a first input mode may allow for selection of a primary transfer source and a second input mode may allow for selection of a secondary transfer source. In a second example, multiple transfer sources may be selected via a single mode. with the primary transfer source being identified based on one or more rules such as, for example, a precedence or priority scheme (e.g., a preference to use deposit accounts as primary transfer source, then debit cards, and then credit cards).

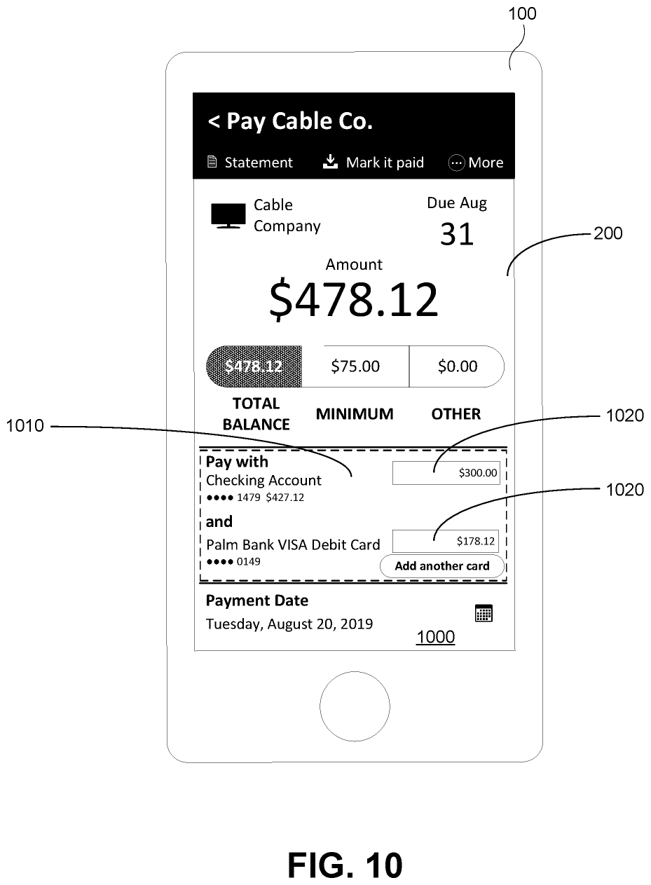

A third example transfer configuration interface 1000 for identifying and selecting a secondary transfer source is shown in FIG. 10. As illustrated, in the third example transfer configuration interface 1000, a list of available transfer sources 1010 is provided that includes a set of data entry fields 1020. Each of the data entry fields 1020 is associated with an available transfer source from the list and may be selected and used to provide input identifying a portion of the value transfer to be satisfied from the associated transfer source. In this way, the value transfer to be apportioned between the different transfer sources. Notably, as input is received in one of the data entry fields 1020, the amount of the others of the data entry fields 1020 so that the total of the values in the data entry fields 1020 is equal to the selected transfer amount (e.g., the total balance of the cable bill, as illustrated). Alternatively, it may be that the amount of the transfer (i.e., the payment amount) is determined based on the total of the values entered into the data entry fields 1020.

In some implementations, the data entry fields 1020 may receive input indicating a relative portion of the amount of the instructed value transfer to be associated with a given transfer source (e.g., a percentage)—i.e., rather than an absolute amount as illustrated). In this way, a secondary transfer source may be selected and the relative portion of the amount of the value transfer to be associated with (e.g., drawn from) the secondary transfer source may be selected by entry into the one of the data entry fields 1020 associated with that transfer. More broadly, in some implementations, user interface controls different from the data entry fields 1020 may be employed. For example, a set of slider controls may be provided allowing the relative portions to be satisfied from each transfer source to be selected visually. Regardless of the manner of user interface and/or the particular type of user interface control used, in the manner described, input may be provided allowing instruction to use an existing secondary transfer source for effectuating at least some of a value transfer that also includes an indication of the relative amount of the transfer to be associated with a given secondary transfer source.

Returning again to discussion of FIG. 5, after secondary transfer source has been identified at the operation 512, an operation 514 is next. At the operation 514, the transfer is configured using the identified primary and secondary transfer sources. For example, the computer system 100 may co-operate with one or more of the first server computer system 110, the second server computer system 130, and the third server computer system 140 to configure and/or effectuate the transfer.

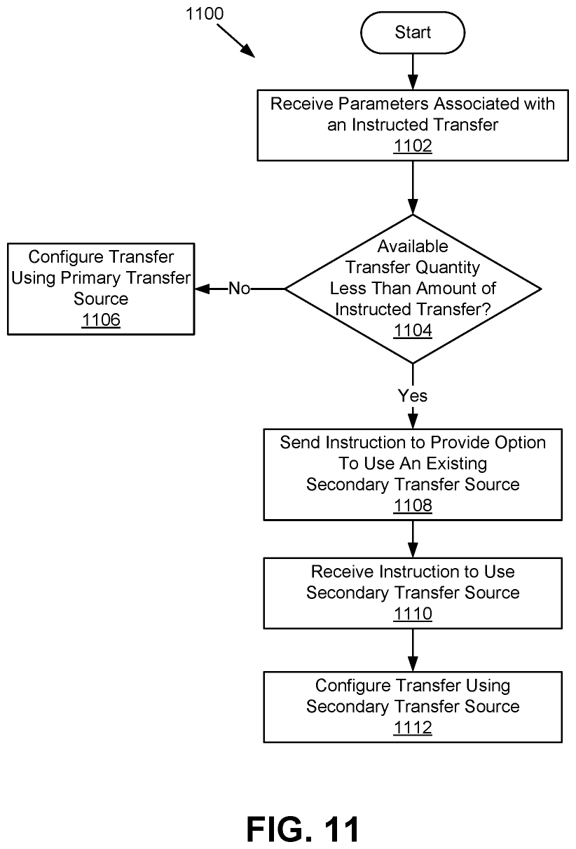

As mentioned above, the computer system 100 may co-operate with one or more remote computing devices such as, for example, the first server computer system 110, the second server computer system 130, and/or the third server computer system 140, in order to configure and/or effectuate a transfer. An example method, a method 1100, such as may be performed by such a remote computer system in configuring a transfer in co-operation with the computer system 100 will now be described with reference to FIG. 11. Notably, the method 1100 may correspond to operations performed by a remote computing device that is co-operating with the computer system 100 as the computer system 100 performs the method 500 (FIG. 5). In any event, in performing the method 1100, operations starting from an operation 1102 and continuing onward are performed by one or more processors of at least one remote computing device executing software comprising instructions. For example, some or all of the operations may be performed by a processor of a computing device of the first server computer system 110.

At the operation 1102, the remote computer system receives parameters associated with a value transfer that is being instructed by way of a client device such as, for example, the computer system 100. The parameters may be received from the client device and/or from another computing device. In a particular example, where the method 1100 is being performed by the first server computer system 110, some or all of the parameters may be received from one or more of the computer system 100, the second server computer system 130 and/or the third server computer system 140. The parameters may be received via a network such as for example, the first network 120 and/or the second network 150. The parameters may be received using a communications module of the remote computer system. Such a communications module may be akin to the communications module 340 (FIG. 3) and may have properties and/or attributes that are the same or similar thereto.

The received parameters include an amount of an instructed value transfer to be made using a primary transfer source for effectuating the instructed value transfer. In some implementations, the received parameters may also identify the primary transfer source. Alternatively, the primary transfer source may be identified in another manner such as, for example, in a manner as was discussed above in relation to the operation 504 of the method 500 (FIG. 5) The primary transfer source may be associated with the remote computer system that is performing the method 1100. Notably, the received parameters may correspond to the parameters obtained at the operation 504 of the method 500.

Following the operation 1102, an operation 1104 is next.

At the operation 1104, it is determined whether an available transfer quantity associated with the primary transfer source identified at the operation 1102 is less than the amount of the value transfer obtained at that same operation. As mentioned above, the primary transfer source may be associated with the computing device performing the method 1100. Accordingly, it may be the operation 1104 includes a query to a database and/or data store associated with the primary transfer source. In a particular example, where the method 1100 is performed by a financial institution server and the primary transfer source is a deposit account associated with that financial institution, the operation 1104 may include one or more queries to establish the available balance in that deposit account. Notably, the operation 1104 may correspond the operation 508 of the method 500 (FIG. 5).

If it is determined that the available transfer quantity is not less than (i.e., is greater than or equal to) the amount of the instructed value transfer, an operation 1106 is next. Alternatively, if it is determined that the available transfer quantity is less than the amount of the instructed value transfer, an operation 1108 is next.

At the operation 1106, having determined that the available transfer quantity is not less than the amount of the instructed value transfer, the transfer is configured for processing from the primary transfer source alone. Notably, this may correspond to configuration of a transfer at the operation 510 of the method 500 (FIG. 5). Accordingly, the transfer sourced from the primary transfer source alone may be configured through co-operation of the remote computing device performing the operation 1106 with one or more other computing devices including the computer system 100.

Alternatively, responsive to determining that the available transfer quantity is less than the amount of the instructed value transfer, at the operation 1108, an instruction is sent, to the client device (e.g., the computer system 100), to provide, on an output module of the client device, a selectable option to use an existing secondary transfer source for effectuating at least a portion of the instructed value transfer. This instruction may, for example, correspond to the instruction such as may trigger the provision of a selectable option to use an existing secondary transfer source at the operation 512 of the method 500 (FIG. 5) as discussed above.

Following the operation 1108, an operation 1110 is next. At the operation 1110, the remote computing device receives, from the client device, an instruction to use a secondary transfer source for effectuating at least a portion of the transfer of value. Notably, this instruction may be received responsive to a selection of a selectable option at the client device, with the selectable option having been provided responsive to the instruction sent at the operation 1108. The instruction may be received from the client device using a communications module of the remote computer system as was discussed above in relation to the operation 1102.

Following the operation 1110, an operation 1112 is next. At the operation 1112, responsive to the instruction received at the operation 1110, the remote computing device configures the instructed transfer of value using the existing secondary transfer source identified in the instruction received at the operation 1112. Additionally or alternatively, the remote computing device may effectuate the transfer. Notably, in performing the operation 1112, the remote computing device may co-operate with one or more other computing devices. For example, the remote computing device may co-operate with one or more of the computer system 100, the second server computer system 130, and the third server computer system 140 to configure and/or effectuate the transfer. Co-operation by the computer system 100 may correspond to performance of the operation 514 of the method 500 (FIG. 5).

In configuring the transfer, the remote computing device may identify amounts to be drawn from each of the primary transfer source and the secondary transfer source. In some implementations, the instruction received at the operation 1110 may identify an amount of the value transfer to be drawn from the primary transfer source and/or from the secondary transfer source. Notably, where one of those amounts is provided, the other may be determined based on a difference between it and the amount of the instructed transfer as instructed. Alternatively, the transfer may be configured with the amount drawn from primary transfer source based on the available transfer quantity associated with the transfer source. For example, all available quantity from the primary transfer source or all available quantity except from some reserve amount may be used to satisfy the transfer before drawing on the secondary transfer source for the balance. In such cases, a difference may then be determined as mentioned above in order to determine the amount of the transfer to be satisfied from the secondary transfer source. For example, where all available quantity from the primary transfer source is to be used to satisfy the transfer before drawing on the secondary transfer source, a difference may be determined between the amount of the instructed value transfer (e.g., as received at the operation 1102) and the available transfer quantity from the primary transfer source and that difference may then be used to configure the transfer of value from the secondary transfer source.

The above description of example embodiments is capable of variation without departing from the subject-matter of the present application. For example, while the above examples include a maximum of two transfer sources (a primary transfer source and secondary transfer source) being used to satisfy a given value transfer, more than two transfer sources may be employed in satisfying a given value transfer. Such variations may be considered, for example, to include more than one secondary transfer source for a given transfer.

Furthermore, example embodiments of the present application are not limited to any particular operating system, system architecture, computing device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer system comprising:
a processor;
a communications module coupled to the processor;
an input module coupled to the processor;
an output module coupled to the processor; and
a memory coupled to the processor and storing instructions associated with a value transfer application, wherein the instructions, when executed by the processor, cause the computer system to:
authenticate, using the communications module, the computer system to a remote server using a credential, the credential associated with an account at the remote server, the account associated with a primary transfer source for effectuating an instructed value transfer;
obtain, using at least one of the input module and the communications module, an amount of the instructed value transfer;
obtain, from the remote server using the communications module, an available transfer quantity associated with the primary transfer source for effectuating the instructed value transfer;
responsive to determining, by the processor, that the available transfer quantity is less than the amount of the instructed value transfer, provide, using the output module, a selectable option to use an existing secondary transfer source for effectuating at least a portion of the instructed value transfer; and
responsive to receiving input via the selectable option to use the existing secondary transfer source for effectuating at least a portion of the instructed value transfer, send, to the remote server using the communications module, an instruction to use the existing secondary transfer source for effectuating the at least a portion of the instructed value transfer.

2. The computer system of claim 1, wherein providing the selectable option to use the existing secondary transfer source for effectuating the at least a portion of the instructed value transfer includes:
providing, using the output module, one or more selectable options to input a relative portion of the amount of the instructed value transfer to be associated with the primary transfer source and a relative portion of the amount of the instructed value transfer to be associated with the secondary transfer source,
wherein the instruction to use the existing secondary transfer source for effectuating the at least a portion of the instructed value transfer includes an indication of the relative portion of the amount of the instructed value transfer to be associated with the secondary transfer source.

3. The computer system of claim 1, wherein the instructions further cause the computer system to:
determine, by the processor, a difference between the amount of the instructed value transfer and the available transfer quantity associated with the primary transfer source,
wherein the instruction to use the existing secondary transfer source for effectuating the at least a portion of the instructed value transfer includes an indication to configure a transfer of value from the secondary transfer source based on the difference.

4. The computer system of claim 1, wherein the primary transfer source includes a deposit account associated with a first financial institution.

5. The computer system of claim 4, wherein the secondary transfer source includes a debit payment from an account associated with a second financial institution, the second financial institution different from the first financial institution.

6. The computer system of claim 4, wherein the value transfer application is a banking application of the first financial institution.

7. The computer system of claim 1, wherein the secondary transfer source is associated with revolving credit facility.

8. The computer system of claim 7, wherein the revolving credit facility includes a credit card account.

9. The computer system of claim 1, wherein the option to use the existing secondary transfer source for effectuating at least a portion of the instructed value transfer includes a selectable option to add the existing secondary transfer source, and wherein the instructions, when executed by the processor, further cause the computer system to:
receive, using the input module, an indication representing selection of the selectable option to add the existing secondary transfer source;
after receiving the indication representing selection of the selectable option to add the existing secondary transfer source, receive, using the input module, information associated with the existing secondary transfer source; and
provide, using the output module, a list of available transfer sources for initiating the instructed value transfer, the list including at least the primary transfer source and the secondary transfer source.

10. The computer system of claim 9, wherein receiving information associated with the existing secondary transfer source includes:
generating, using the output module, a prompt for input of identification data associated with the existing secondary transfer source;
receiving, using the input module, the identification data; and
verifying the identification data.

11. A computer system comprising:
a processor;
a communications module coupled to the processor; and
a memory coupled to the processor and storing instructions that, when executed by the processor, cause the computer system to:
obtain, using the communications module from one of a client device and a remote server system, an amount of an instructed value transfer to be made using a primary transfer source for effectuating the instructed value transfer, the primary transfer source associated with the computer system;
responsive to determining, by the processor, that an available transfer quantity associated with the primary transfer source for effectuating the instructed value transfer is less than the amount of the instructed value transfer, send, to the client device, an output instruction to provide, on an output module of the client device, a selectable option to use an existing secondary transfer source for effectuating at least a portion of the instructed value transfer;
receive, from the client device using the communications module, an instruction to use the secondary transfer source for effectuating the at least a portion of the instructed value transfer; and
responsive to receiving the instruction to use the existing secondary transfer source for effectuating at least the at least a portion of the instructed value transfer, configure the instructed transfer of value using the existing secondary transfer source.

12. The computer system of claim 11, wherein the instructions further cause the computer system to:
determine, by the processor, a difference between the amount of the instructed value transfer and the available transfer quantity associated with the primary transfer source,
wherein the transfer of value from the secondary transfer source is configured based on the difference.

13. The computer system of claim 11, wherein the primary transfer source includes a deposit account associated with a first financial institution.

14. The computer system of claim 13, wherein the secondary transfer source includes a debit payment from an account associated with a second financial institution, the second financial institution different from the first financial institution.

15. The computer system of claim 11, wherein the secondary transfer source is associated with revolving credit facility.

16. A computer-implemented method comprising:
obtaining an amount of an instructed value transfer to be made using a primary transfer source for effectuating the instructed value transfer;
responsive to determining that an available transfer quantity associated with the primary transfer source for effectuating the instructed value transfer is less than the amount of the instructed value transfer, providing a selectable option to use an existing secondary transfer source for effectuating at least a portion of the instructed value transfer; and
responsive to receiving, based on the selectable option to use the existing secondary transfer source for effectuating at least the at least a portion of the instructed value transfer, initiating a transfer of value using the existing secondary transfer source for effectuating the at least a portion of the instructed value transfer.

17. The computer-implemented method of claim 16, further comprising:
receiving an indication of input defining a relative portion of the amount of the instructed value transfer to be associated with the primary transfer source and a relative portion of the amount of the instructed value transfer to be associated with the secondary transfer source,
wherein the transfer of value from the secondary transfer source is configured based on the relative portion of the amount of the instructed value transfer to be associated with the secondary transfer source.

18. The computer-implemented method of claim 16, further comprising:
determining a difference between the amount of the instructed value transfer and the available transfer quantity associated with the primary transfer source,
wherein the transfer of value from the secondary transfer source is configured based on the difference.

19. The computer-implemented method of claim 16, wherein the primary transfer source includes a deposit account associated with a first financial institution.

20. The computer-implemented method of claim 16, wherein the secondary transfer source includes a credit card account.
